(19) United States
(12) Patent Application Publication
(10) Pub. No.: US 2009/0103138 A1
(43) Pub. Date: Apr. 23, 2009

(54) IMAGE FORMING INDICATING TERMINAL AND IMAGE FORMING INDICATING METHOD

(75) Inventor: Masashi Honda, Tagata-gun (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/874,429

(22) Filed: Oct. 18, 2007

(51) Int. Cl. G06F 15/16

(52) U.S. Cl. 358/1.18; 358/1.15

(57) ABSTRACT

An image forming indicating terminal of an example of the invention includes a storage unit to store a first print condition, an input unit to input a second print condition when printing of data is executed, a calculation unit to calculate the second print condition inputted by the input unit, a comparison unit to compare an upper limit of the first print condition stored in the storage unit with the second print condition calculated by the calculation unit, and a display unit to display a warning when a comparison result of the comparison unit satisfies a specified condition.

### BACKGROUND OF THE INVENTION

1. Field of the Invention

The present invention relates to an image forming indicating terminal to transmit print processing.

2. Description of the Related

As is well known, in recent years, there is an image forming apparatus having plural functions such as a copy function, a facsimile function, a scanner function, a printer function or an image filing function. Besides, the image forming apparatus as stated above is connected to, for example, an arbitrary number of personal computers (hereinafter referred to as PCs) and the outside through a network. Thus, data captured by the image forming apparatus can be taken into the PC or can be transmitted to the outside.

As the speed of printing by the image forming apparatus is increased, a large number of sheets can be easily printed. However, when a user instructs printing to the image forming apparatus by using an image forming indicating terminal, there is a case where a large value of the designated printing number of sheets designated in the former print job or a designated value of the number of copies remains, or the data itself of the print object has a large number of pages. At this time, there can occur a case where the user does not notice such a state but clicks a print execution button, and wasteful printing is performed. Besides, even if the user notices that the wasteful printing is executed and presses a print cancel button, since the print job is instantaneously transferred to an RIP processing apparatus, it has been difficult to cancel the printing.

JP-A-2-111973 discloses a structure of a copying apparatus which includes warning means for issuing a warning when comparison means for comparing the allowed copying number of sheets and the executed copying number of sheets set before the copying determines that the executed copying number of sheets exceeds the allowed copying number of sheets.

Besides, JP-A-9-106223 discloses a structure in which the upper limit of the number of copied sheets inputted by an operator is limited, and when the number of copied sheets exceeds the limiting value, that is displayed on an operation panel, and the inputted number of copied sheets is corrected to the limiting value.

Besides, JP-A-8-227252 discloses a structure in which it is determined whether the total copying number of sheets is larger than the number of transfer sheets, and when it is larger, a warning or another necessary display is made, and according to this display, an operator replenishes the transfer sheets or changes the copy setting, and copying is executed.

However, the structure disclosed in JP-A-2-111973, JP-A-9-106223 or JP-A-8-227252 is the structure for the copying machine. Thus, there is no disclosure of a structure in which in a case where printing of a large number of sheets unexpected by a user is instructed, the printing is prevented from occurring.

### BRIEF SUMMARY OF THE INVENTION

It is therefore an object of the invention to provide an image forming indicating terminal which prevents printing unexpected by a user.

According to an aspect of the invention, an image forming indicating terminal includes storage means for storing a first print condition, input means for inputting a second print condition when printing of data is executed, calculation means for calculating the second print condition inputted by the input means, comparison means for comparing an upper limit of the first print condition stored in the storage means with the second print condition calculated by the calculation means, and display means for displaying a warning when a comparison result of the comparison means satisfies a specified condition.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the outer appearance of an image forming indicating terminal of an embodiment of the invention and an image forming apparatus.

FIG. 2 is a block diagram showing the image forming indicating terminal of the embodiment of the invention.

FIG. 3 is a block diagram showing the structure of the image forming apparatus of the embodiment of the invention.

FIG. 4 is a view showing a display on a display unit of the image forming indicating terminal of the embodiment of the invention.

FIG. 5 is a view showing a display on the display unit of the image forming indicating terminal of the embodiment of the invention.

FIG. 6 is a flowchart showing a print instruction of image data by the image forming indicating terminal of the embodiment of the invention.

### DETAILED DESCRIPTION OF THE INVENTION

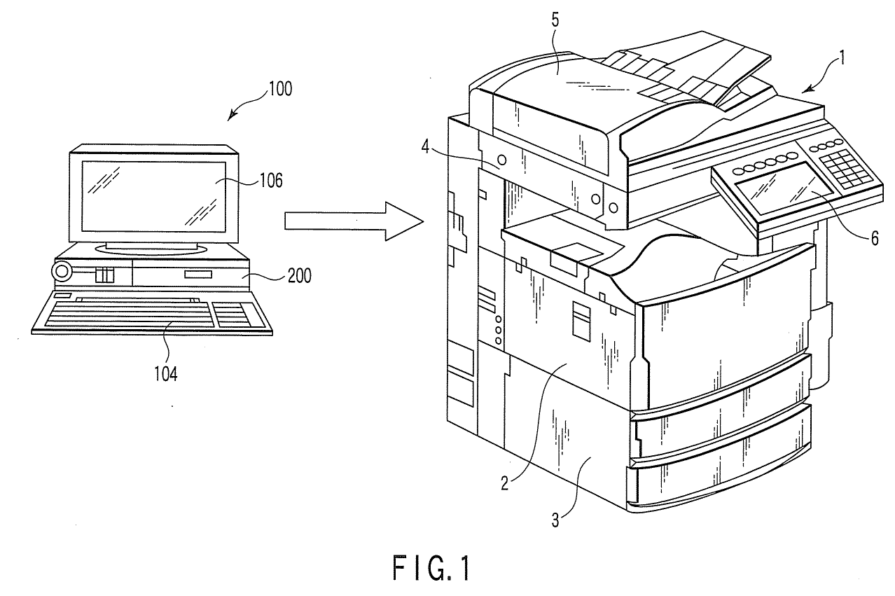

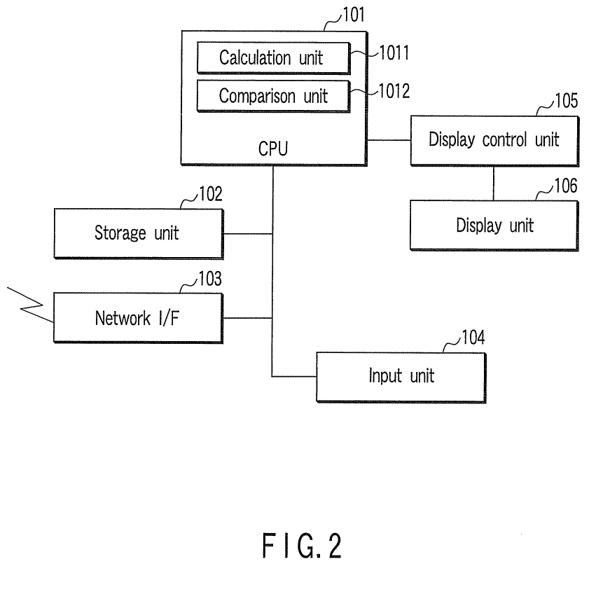

Hereinafter, an embodiment of the invention will be described with reference to the drawings. FIG. 1 shows a main part of an image forming indicating terminal to which the invention can be applied and an image forming apparatus. The image forming indicating terminal 100 is, for example, a PC (Personal Computer). Hereinafter, it is assumed that the PC is the image forming indicating terminal, and a description will be made. FIG. 1 shows the outer appearance of the PC 100. The PC 100 includes a display unit 106 to display image data, an input unit 104 by which a user inputs various conditions, and a processing unit 200 having a CPU 101 to perform control and operation processing on the PC 100, a storage unit 102 and the like which are shown in FIG. 2.

Besides, the image forming apparatus 1 includes an image formation unit main body 2 to output image data as an output image called, for example, a hard copy or printout, a sheet supply unit 3 capable of supplying a sheet (output medium) of an arbitrary size used for image output to the image formation unit main body 2, and a scanner unit (image reading unit) 4 to capture, as image data, image data, which is an object of image formation in the image formation unit main body 2, from an object (hereinafter referred to as an original document) holding the image data. Incidentally, the scanner unit 4 is integrally provided with an auto document feeder 5 in which in a case where original documents are sheet-like, after formation of image output or capture of image data (hereinafter referred to as reading) is ended, an original document after the completion of the reading is discharged from a read position to a discharge position, and a next original document is guided to the read position. Besides, an instruction input unit to instruct the start of image formation in the image formation unit main body 2 or the start of reading of the image data of the original document by the scanner 4, that is, a control panel (operation unit) 6 is provided at a specified position of the image forming apparatus 1, for example, the edge of the front of the image reading unit 4.

FIG. 2 is a block diagram showing a structure of a control system of the image forming indicating terminal to which the invention can be applied. As shown in FIG. 2, the PC 100 includes the CPU 101, the storage unit 102, a network interface 103, the input unit 104, a display control unit 105 and the display unit 106.

The CPU 101 executes a program stored in the storage unit 102 such as a ROM (Read Only Memory), a NVM (Non-volatile memory) or a hard disk drive (HDD). Besides, the CPU 101 includes a calculation unit 1011 and a comparison unit 1012. The calculation unit 1011 performs a specific calculation processing on the setting which the user inputs by using the input unit 104. The comparison unit 1012 compares two or more designated conditions and makes a determination. The storage unit 102 stores various data such as various setting data, management data, control programs or control data. The network interface 103 communicates data through a network. The PC 100 can transfer image data to the image forming apparatus 1 connected through the network interface 103. The input unit 104 can input various settings and can determine processing. The display control unit 105 controls a screen to be displayed on a display unit 106. The display control unit 105 reads a program and control data stored in the storage unit 102 based on input information which the user inputs by using the input unit 104 and displays the screen. The display unit 106 is a display and is for displaying the screen controlled by the display control unit 105.

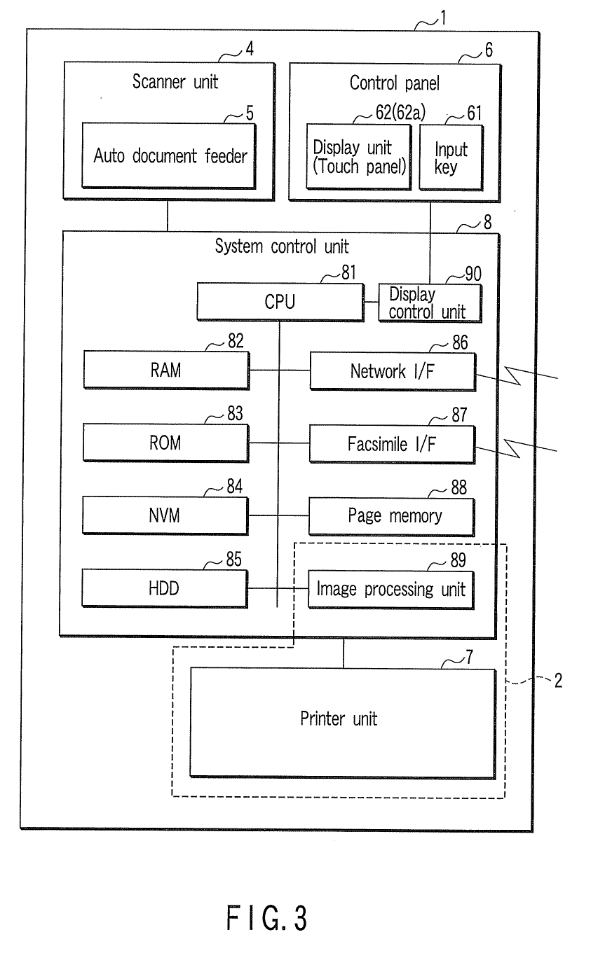

FIG. 3 is a block diagram showing a structure of a control system of the image forming apparatus to which the invention can be applied. As shown in FIG. 3, in this image forming apparatus 1, a system control unit 8 is connected with the control panel 6, the scanner unit 4, and the printer unit 7.

The system control unit 8 controls the control panel 6, the scanner unit 4, the printer unit 7 and the like. Besides, the system control unit 8 has various functions to perform processing based on signals supplied from the control panel 6, the scanner unit 4 and the printer unit 7.

The control panel 6 includes an input key 61 and a display unit 62 having a built-in touch panel 62a. An operation guide, a key (icon) selectable by the touch panel 62a and the like are displayed on the display unit 62 based on the display control of the system control unit 8. In the control panel 6, the user can input the icon selectable by the input key 61 or the touch panel 62a. The information (information indicating the icon selectable by the input key 61 pressed by the user or the touch panel 62a touched by the user) which the user inputs in the control panel 6 is supplied to the system control unit 8.

The scanner unit 4 converts an image of an original document into image data based on the control of the system control unit 8. The scanner unit 4 converts the image of the original document into color or black and white digital image data. The scanner unit 4 supplies the digital image data as the image of the read original document to the system control unit 8.

The printer unit 7 prints the image on a sheet as an image-formed medium based on the control by the system control unit 8. Besides, the result of print processing by the printer unit 7 is notified to the system control unit 8. The printer unit 7 performs color printing to form a color image on the image-formed medium based on the color image data, or black and white printing to form a black and white image on the image-formed medium based on the black and white image data. The printer unit 7 includes, for example, a transport unit (not shown) to transport the image-formed medium, and an image formation unit (not shown) to form the color image or the black and white image on the image-formed medium transported by the transport unit.

Besides, as shown in FIG. 3, the system control unit 8 includes a CPU (Central Processing Unit) 81, a RAM (Random Access Memory) 82, a ROM (Read Only Memory) 83, a NVM (Non-volatile memory) 84, a hard disk drive (HDD) 85, a network interface (Interface) 86, a facsimile interface (Interface) 87, a page memory 88, an image processing unit 89, a display control unit 90, a wireless communication unit 91, a wireless reader 92 and the like.

The CPU 81 executes a program stored in the ROM 83, the NVM 84 or the HDD 85. For example, the auto document feeder 5 is realized in such a way that the CPU 81 executes a control program based on a program and control data stored in the ROM 83, the NVM 84 or the HDD 85. Besides, the display control of the display unit 62 in the control panel 6 is executed by the CPU 81 based on a program and control data stored in the NVM 84 or the ROM 83.

The RAM 82 is a memory for temporarily storing data for working or data for reference. Besides, the RAM 82 is used as a main memory for executing various processings based on various control programs. For example, in the RAM 82, the control program and control data are read at the time of operation of the image forming apparatus 1, and information to be temporarily stored, such as information indicating the present setting content, is also stored.

As the setting content, for example, in a copy mode, there are a copy magnification, the number of copies, and the like in addition to original document setting and sheet setting.

The ROM 83 is a non-volatile memory. In the ROM 83, for example, the control program and control data for controlling the image forming apparatus 1 are stored. Besides, in the ROM 83, image data to be displayed on the display unit 62 of the control panel 6 is stored.

The NVM 84 is a rewritable non-volatile memory. Data such as system setting information is stored in the NVM 84. Besides, in the NVM 84, image data to be displayed on the display unit 62 of the control panel 6 may be stored.

The HDD 85 is a large-capacity storage device. In the HDD 85, various data such as various setting data, management data, control programs or control data are stored. Image data to be displayed on the display unit 62 of the control panel 6 is also stored in the HDD 85. Besides, the image data read by the scanner unit 4 may also be stored in the HDD 85. Further, the HDD 85 may be used as a backup memory for various memories.

The network interface 86 receives data transferred through the network interface 103 of the PC 100 based on the instruction of print execution of the PC 100. In the image forming apparatus 1, a network print function is realized in which print data from an external equipment connected through the network by the network interface 86 is printed on a sheet.

The facsimile interface 87 is for transmitting and receiving facsimile data. In the image forming apparatus 1, the fax function is realized by using the facsimile interface 87. For example, the facsimile reception processing is realized in such a way that the facsimile data received by the facsimile interface 87 is black and white printed by the printer unit 7. Besides, the facsimile transmission processing is realized in such a way that the image data of an original document read by the scanner unit 4 is converted into facsimile data by the facsimile interface 87 and is transferred to a transmission destination.

The page memory 88 is a memory in which image data to be printed by the printer unit 7 is stored. The page memory 88 is controlled by a not-shown page memory controller. For example, in the case where the printer unit 7 performs a print processing, color image data or black and white image data of each page to be printed by the printer unit 7 is expanded (stored) in the page memory 88.

The image processing unit 89 is for performing various image processings on the image data. In the image processing unit 89, for example, the data scanned by the scanner unit 4 is compressed and is expanded for printout.

The display control unit 90 controls a screen to be displayed on the display unit 62. The display control unit 120 reads a program and control data stored in the NVM 84 or the ROM 83 based on the input information of an icon selectable by the user by means of the input key 61 or the touch panel 62a, and displays the screen.

The wireless communication unit 91 performs data communication by wireless and via mail or the like. In the image forming apparatus 1, information to notify the replacement of a consumable can be transmitted via mail to a previously registered mail address (for example, the mail address of a portable terminal 20 owned by an administrator).

The wireless reader 92 is for reading storage information stored in a wireless tag 101 provided on a consumable when the consumable is replaced. The wireless reader 92 is provided at a position where the wireless tag 101 provided on a consumable can be read and one wireless reader corresponds to one place as a position where the consumable is mounted. That is, the wireless readers 92, the number of which is equal to the number of consumables which can be replaced, are provided in the image forming apparatus 1.

Next, a description will be given to the designation of printing execution to the image forming apparatus 1 from the PC 100. On a printer driver screen, the user sets a value of the number of sheets so that a warning message is displayed on the display unit 106 of the PC 100 when the product of the designated number of copies and the designated printing number of sheets is the value or more. Here, it is assumed that the user designates, for example, 100 as the designated value of the warning printing number of sheets based on which the warning message shown in FIG. 5 is displayed on the display unit 106 of the PC 100.

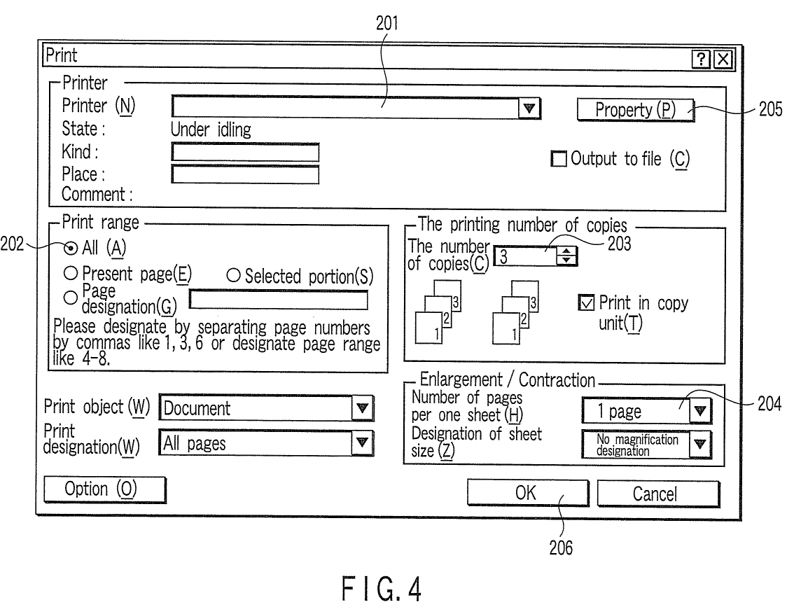

When the user desires to print electronic data displayed on the display unit 106 of the PC 100, the user selects a print command. When the print command is selected, the display control unit 105 displays a screen shown in FIG. 4. The screen shown in FIG. 4 is the printer driver screen for setting the details relating to the printing of the electronic data.

The user designates a printer for printing the electronic data by a printer name selection unit 201. On the printer driver screen, the user designates a print range (that is, the designated printing number of sheets) by a print range selection unit 202, designates the printing number of copies by a printing number of copies selection unit 203, designates a print layout by an enlargement/contraction selection unit 204, and designates a sheet size, color/monochrome print setting, single-side/double-side printing setting and the like by a property 205. The print layout is Nin1 in which the output for N sheets is outputted by one sheet. On the printer driver screen shown in FIG. 4, the user can perform the print setting on the electronic data whose printing is desired.

Here, on the printer driver screen shown in FIG. 5, the user designates that the printer is the image forming apparatus 1, that the print size is A4, that the printing number of copies is 3, and that the designated printing number of sheets per one copy is 50. A state in which the user depresses a print execution button 206 in the above print setting will be described.

At this time, the calculation unit 1011 of the CPU 101 calculates that the printing number of sheets obtained as print setting by the product of the printing number of copies of 3 and the designated printing number of sheets of 50 is 150. The comparison unit 1012 of the CPU 101 compares whether the product of the printing number of copies and the designated printing number of sheets is not smaller than the warning printing number of sheets for displaying the warning message on the display unit 106 of the PC 100. Since the product of the printing number of copies and the designated printing number of sheets is 150, and the warning printing number of sheets is 100, the comparison unit 1012 of the CPU 101 determines that the product of the printing number of copies and the designated printing number of sheets is not smaller than the warning printing number of sheets. The display control unit 105 displays the warning message shown in FIG. 5 on the display unit 106. The user can confirm the warning message on the display unit 106. When the user determines that there is no error in the printing number of copies and the designated printing number of sheets, the user depresses the OK button, and the CPU 101 of the PC 100 transfers the electronic data to the image forming apparatus 1. The print unit 2 of the image forming apparatus 1 prints based on the electronic data. When determining that there is an error in the printing number of copies and the designated printing number of sheets, the user depresses the cancel button, so that the CPU 101 of the PC 100 does not transfer the electronic data to the image forming apparatus 1. Then, since a return is made to the printer driver screen shown in FIG. 4, the user can change the print setting of the printing number of copies and the designated printing number of sheets.

Next, on the printer driver screen, the user designates that the printer is the image forming apparatus 1, that the sheet size is A4, that the printing number of copies is 3, and that the designated printing number of sheets per one copy is 10. A state in which the user depresses the print execution button in the above print setting will be described.

At this time, the calculation unit 1011 of the CPU 101 calculates that the printing number of sheets obtained as print setting by the product of the printing number of copies of 3 and the designated printing number of sheets of 10 is 30. The comparison unit 1012 of the CPU 101 compares whether the product of the printing number of copies and the designated printing number of sheets is not smaller than the warning printing number of sheets for displaying the warning message on the display unit 106 of the PC 100. Since the product of the printing number of copies and the designated printing number of sheets is 30, and the warning printing number of sheets for displaying the warning message on the display unit 106 of the PC 100 is 100, the comparison unit 1012 of the CPU 101 determines that the product of the printing number of copies and the designated printing number of sheets is smaller than the warning printing number of sheets. Thus, the CPU 101 of the PC 100 transfers the image data to the image forming apparatus 1, and the printer unit 2 of the image forming apparatus 1 prints based on the image data.

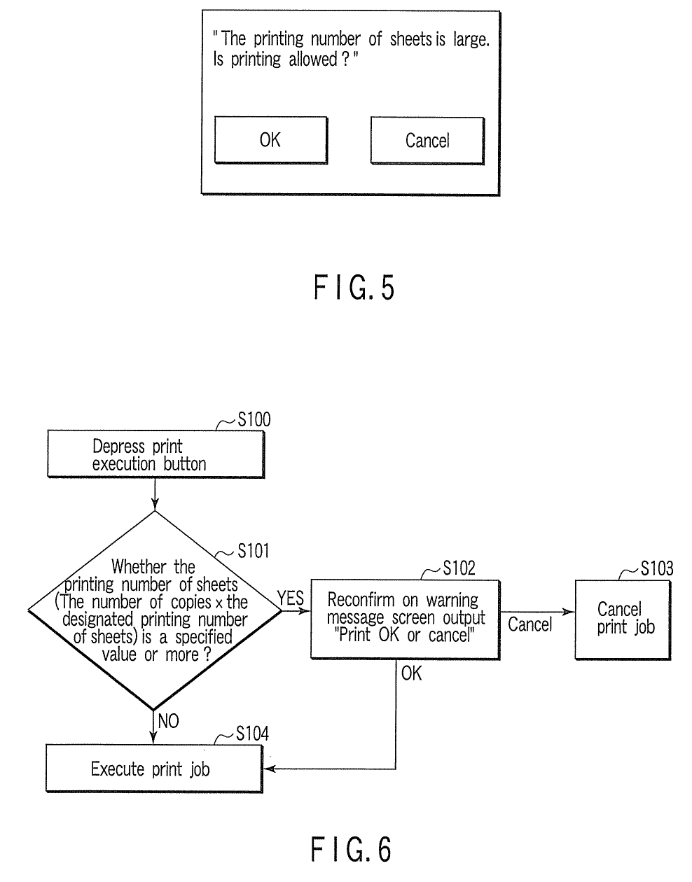

FIG. 6 is a flowchart showing the print execution described above. First, on the printer driver screen, the user designates that the printer is the image forming apparatus 1, and sets the printing number of copies, the designated printing number of sheets per one copy and the like. Then, the user depresses the print execution button in the above setting condition (step S100).

The calculation unit 1011 of the CPU 101 calculates the product of the printing number of copies and the designated printing number of sheets. The comparison unit 1012 of the CPU 101 compares whether the product of the printing number of copies and the designated printing number of sheets is not smaller than the warning printing number of sheets for displaying the warning message on the display unit 106 of the PC 100 (step S101). When the comparison unit 1012 of the CPU 101 determines that the product of the printing number of copies and the designated printing number of sheets set by the user is not smaller than the warning printing number of sheets (step S101, YES), the display control unit 105 displays the warning message indicating the print OK or the print cancel on the display unit 106 (step S102). Since the user can confirm the warning message on the display unit 106, the user can determine whether there is an error in the printing number of copies and the designated printing number of sheets. When the user determines that there is no error in the printing number of copies and the designated printing number of sheets and depresses the OK button, the CPU 101 of the PC 100 transfers the image data to the image forming apparatus 1. The printer unit 2 of the image forming apparatus 1 prints based on the image data (step S104). When the user determines that there is an error in the printing number of copies and the designated printing number of sheets and depresses the cancel button, the CPU 101 of the PC 100 does not transfer the image data to the image forming apparatus 1 and cancels the print job (step S103).

Besides, when the comparison unit 1012 of the CPU 101 determines that the product of the printing number of copies and the designated printing number of sheets set by the user is smaller than the warning printing number of sheets (step S101, NO), the CPU 101 of the PC 100 transfers the image data to the image forming apparatus 1, and the printer unit 2 of the image forming apparatus 1 prints based on the image data (step S104).

At step S102, when the warning message indicating the print OK or the print cancel is displayed on the printer driver screen, the display control unit 105 can display, on the display unit 106, a condition under which the product of the printing number of copies and the designated printing number of sheets does not exceed the warning printing number of sheets or a condition under which a difference between the product of the printing number of copies and the designated printing number of sheets and the upper limit of the warning printing number of sheets is reduced. For example, the display control unit 105 displays at least one of a change in the single-side/double-side printing and a change in Nin1, and the product of the printing number of copies and the designated printing number of sheets can be decreased.

When the user performs the print setting of first image data on the printer driver screen shown in FIG. 4, it is assumed that for example, the printing number of copies is set to 10, and printing is executed on the first image data. Thereafter, the user displays second image data on the display unit 106 of the PC 100, and when the print setting of the second image data is performed on the printer driver screen shown in FIG. 4, there can occur a case where the printing number of copies remains the printing number of copies of 10 set on the first image data. When the user desires to print only one copy of the second image data, it is conceivable that the user misunderstands that the printing number of copies is one which is a specified value in the printing number of copies selection unit 203, and depresses the OK button 206 for the print execution of the second image data.

Besides, for example, with respect to electronic data of an instruction manual, when the user desires to print a part of the instruction manual, it is conceivable that the user carelessly performs print setting of all of the electronic data of the instruction manual. Thus, in the case where the user performs a large amount of print setting, a warning message to warn the user about whether the printing may be truly performed is displayed on the printer driver screen, so that the printing unexpected by the user can be prevented, and the wasteful consumption of the time, paper and consumables can be prevented.

In the description, as the designated value for displaying the warning message on the printer driver screen, the warning printing number of sheets is set to 100. Here, the designated value for displaying the warning message on the printer driver screen can be set for each printed paper size or each color/monochrome print. As the paper size becomes large, the printing time becomes long, and the printing time of the color print becomes longer than that of the monochrome print. Although the designated value for displaying the warning message on the printer driver screen is determined by the product of the printing number of copies and the designated printing number of sheets, the value of only the designated printing number of sheets or only the printing number of copies may be used.

Here, the designated value for displaying the warning message on the printer driver screen may be the number of picture dots. Based on the sheet size, the printing number of sheets, the designated printing number of sheets per one copy, and the color/monochrome print setting set by the user on the printer driver screen shown in FIG. 5, the calculation unit 1011 of the CPU 101 of the image forming indicating terminal 100 can calculate the number of picture dots in the print setting. The comparison unit 1012 of the CPU 101 can compare the number of picture dots of the designated value with the number of picture dots calculated by the calculation unit 1011. The designated value for displaying the warning message on the printer driver screen may be a printing time. Based on the sheet size, the printing number of copies, the designated printing number of sheets per one copy, and the color/monochrome print setting set by the user on the driver screen shown in FIG. 5, the CPU 101 of the image forming indicating terminal 100 can calculate the printing time. The comparison unit 1012 of the CPU 101 can compare the printing time of the designated value with the printing time calculated by the calculation unit 1011.

Further, the designated value for displaying the warning message on the printer driver screen may be a printing fee. Based on the sheet size, the printing number of copies, the designated printing number of sheets per one copy, and the color/monochrome print setting set by the user on the driver screen shown in FIG. 5, the calculation unit 1011 of the CPU 101 of the image forming indicating terminal 100 can calculate the printing fee in the set printing. The comparison unit 1012 of the CPU 101 can compare the printing fee of the designated value with the printing fee calculated by the calculation unit 1011. Thus, in the case where the user uses the image forming apparatus 1 in which printing is charged, it is possible to prevent a large fee from being charged for printing unexpected by the user.

Here, when the warning message indicating the print OK or print cancel is displayed on the printer driver screen, the display control unit 105 can display, on the display unit 106, a condition under which the printing fee, the number of picture dots, or the printing time calculated by the calculation unit 1011 does not exceed the printing fee, the number of picture dots or the printing time as the designated value, or a condition under which a difference between the printing fee, the number of picture dots or the printing time calculated by calculation unit 1011 and the printing fee, the number of picture dots or the printing time as the designated value is reduced. This becomes possible when the display control unit 105 displays, for example, at least one of a change in paper size, a change in single-side/double-side printing, a change in Nin1, a change in color/monochrome print, and a change in paper feed method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming indicating terminal comprising:
storage means for storing a first print condition;
input means for inputting a second print condition when printing of data is executed;
calculation means for calculating the second print condition inputted by the input means;
comparison means for comparing an upper limit of the first print condition stored in the storage means with the second print condition calculated by the calculation means; and
display means for displaying a warning when a comparison result of the comparison means satisfies a specified condition.

2. The image forming indicating terminal according to claim 1, further comprising setting means for setting the first print condition for each outputted paper size or each color/monochrome print.

3. The image forming indicating terminal according to claim 1, wherein the specified condition is a case where the second print condition exceeds the upper limit of the first print condition.

4. The image forming indicating terminal according to claim 1, wherein
based on the display of the warning, the display means displays at least one of a change in paper size, a change in single-side/double-side printing, a change in Nin1, a change in color/monochrome print, and a change in paper feed method as a condition under which a difference between the upper limit of the first print condition and the second print condition is reduced.

5. The image forming indicating terminal according to claim 1, wherein
the first print condition is the printing number of sheets, and the second print condition is the printing number of sheets obtained by a product of the printing number of copies inputted by the input means and the designated printing number of sheets per one copy.

6. The image forming indicating terminal according to claim 1, wherein each of the first print condition and the second print condition is a printing fee.

7. The image forming indicating terminal according to claim 1, wherein each of the first print condition and the second print condition is the number of picture dots.

8. The image forming indicating terminal according to claim 1, wherein each of the first print condition and the second print condition is a printing time.

9. An image forming indicating method comprising:
storing a first print condition;
inputting a second print condition when printing of data is executed;
comparing an upper limit of the first print condition with the second print condition inputted by the input means; and
displaying a warning when a comparison result satisfies a specified condition.

10. The image forming indicating method according to claim 9, wherein the first print condition is set for each outputted paper size or each color/monochrome print.

11. The image forming indicating method according to claim 9, wherein the specified condition is a case where the second print condition exceeds an upper limit of the first print condition.

12. The image forming indicating method according to claim 9, wherein
based on the display of the warning, the display means displays at least one of a change in paper size, a change in single-side/double-side printing, a change in Nin1, a change in color/monochrome print, and a change in paper feed method as a condition under which a difference between an upper limit of the first print condition and the second print condition is reduced.

13. The image forming indicating method according to claim 9, wherein
the first print condition is the printing number of sheets, and the second print condition is the printing number of sheets obtained by a product of the printing number of copies inputted by the input means and the designated printing number of sheets per one copy.

14. The image forming indicating method according to claim 9, wherein each of the first print condition and the second print condition is a printing fee.

15. The image forming indicating method according to claim 9, wherein each of the first print condition and the second print condition is the number of picture dots.

16. The image forming indicating method according to claim 9, wherein each of the first print condition and the second print condition is a printing time.

17. An image forming system comprising:
storage means for storing a first print condition;
input means for inputting a second print condition when printing of data is executed;
comparison means for comparing an upper limit of the first print condition stored in the storage means with the second print condition inputted by the input means;
display means for displaying a warning when the second print condition exceeds the upper limit of the first print condition in a comparison result of the comparison means;
transmission means for transmitting the data when the second print condition is smaller than the upper limit of the first print condition in the comparison result of the comparison means;
reception means for the data transmitted by the transmission means; and
print means for printing the date received by the reception means.

18. The image forming system according to claim 17, further comprising setting means for setting the first print condition for each outputted paper size or each color/monochrome print.

19. The image forming indicating terminal according to claim 17, wherein the specified condition is a case where the second print condition exceeds the upper limit of the first print condition.

20. The image forming system according to claim 17, wherein
based on the display of the warning, the display means displays at least one of a change in paper size, a change in single-side/double-side printing, a change in Nin1, a change in color/monochrome print, and a change in paper feed method as a condition under which a difference between the upper limit of the first print condition and the second print condition is reduced.
